(19) United States
(12) Patent Application Publication
(10) Pub. No.: US 2021/0350305 A1
(43) Pub. Date: Nov. 11, 2021

(54) NOTIFYING KEY PERFORMANCE INDICATORS OF INTEREST IN A BUSINESS INTELLIGENCE SYSTEM

(71) Applicant: Oracle International Corporation, Redwood Shores, CA (US)

(72) Inventors: Anand Kumar Singh, Hyderabad (IN); Tanmoy Bhowmik, Bangalore (IN); Anirban Majumdar, Hyderabad (IN)

(21) Appl. No.: 16/946,384

(22) Filed: Jun. 19, 2020

(30) Foreign Application Priority Data
May 7, 2020 (IN) 202041019412

(51) Int. Cl. G06Q 10/06; G06F 17/18

(52) U.S. Cl. CPC G06Q 10/06393; G06F 17/18

(57) ABSTRACT

A BI system identifies key performance indicators (KPIs) of interest for a given time duration without requiring any user inputs for such purpose. In other words, the user may provide inputs for purposes such as specifying the time duration, for initiation of execution of modules to trigger the identification, etc., but no user inputs may be required for such identification itself. In an embodiment, the KPIs of interest are determined by examining a corresponding sequence of measurements for each key performance indicator (KPI). The KPIs thus identified are sent for display.

### PRIORITY CLAIM

The instant patent application is related to and claims priority from co-pending India application entitled, “NOTIFYING KEY PERFORMANCE INDICATORS OF INTEREST IN A BUSINESS INTELLIGENCE SYSTEM”, Application Number: 202041019412, filed on: 7 May 2020, First Named Inventor: Anand Kumar Singh, which is incorporated in its entirety herewith.

### RELATED APPLICATION

The instant application is related to co-pending India Patent Application No: UNASSIGNED, Entitled, “AIDING FURTHER EXAMINATION OF A DATA SET FOR IMPROVING A CORRESPONDING KEY PERFORMANCE INDICATOR (KPI)”, inventors Tanmoy Bhowmik, Anand Kumar Singh and Anirban Majumdar, Filed: On even date herewith; Attorney Docket No: ORCL-234-US, which is incorporated in its entirety herewith.

### BACKGROUND OF THE DISCLOSURE

### Technical Field

The present disclosure relates to business intelligence (BI) systems and more specifically to notifying KPIs of interest in BI systems.

### Related Art

Business intelligence systems refer to systems containing a set of tools and processes using which businesses can analyze and gain insights from large amounts of data. As may be readily appreciated, businesses often collect and/or procure from others, such large amount of data as relevant to their business operations.

A key performance indicator (KPI) refers to a measure of an aspect of interest that can be determined by analysis of such data in a BI system. For example, KPIs relevant to a business firm may be aggregate sales quantum, employee turnover, etc.

It is generally understood that critical examination of KPIs can be a basis for actionable items such as decision-making, resource planning, and evaluation of risks, etc., with the broader goal of improving the KPIs. For example, a sales executive may examine the data with a view to improving aggregate sales.

However, there may be a large number of KPIs in a BI system providing information about different aspects of the business. The examination of a large number of KPIs may become cumbersome and complex.

Aspects of the present disclosure are directed to notifying KPIs of particular interest in a BI system.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which KPIs of interest are notified in a BI system according to an aspect of the present disclosure.

FIG. 3A depicts sample projected values for KPI “number of customers” up to a first time duration in an embodiment.

FIG. 3B depicts sample projected values for KPI “monthly profit” up to the first time duration in an embodiment.

FIG. 3C depicts sample projected values for KPI “monthly investment” up to the first time duration in an embodiment.

FIG. 3D depicts sample projected values for KPI “new customers” up to the first time duration in an embodiment.

FIG. 4A depicts the inputs and outputs for identifying if the KPI “number of customers” is of interest up to the first time duration in an embodiment.

FIG. 4B depicts the inputs and outputs for identifying if the KPI “monthly profit” is of interest up to the first time duration in an embodiment.

FIG. 4C depicts the inputs and outputs for identifying if the KPI “monthly investment” is of interest up to the first time duration in an embodiment.

FIG. 4D depicts the inputs and outputs for identifying if the KPI “new customers” is of interest up to the first time duration in an embodiment.

FIGS. 5A-5D depict sample projected values for the illustrative KPIs for a second time duration, having an extension to the first time duration in an embodiment.

FIGS. 6A-6D depict the inputs and outputs for identifying if the illustrative KPIs are of interest for the second time duration in an embodiment.

FIG. 7A depicts a sample dashboard presented to an end user at a time point at the end of the first time duration in an embodiment.

FIG. 7B depicts a sample dashboard presented to an end user at a time point at the end of the second time duration in an embodiment.

FIG. 8 depicts a sample dashboard presented to an end user for several time durations in an embodiment.

FIG. 9 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Terminology

KPI: A numerical measure of an aspect of interest generated by analyzing data in a BI system.

Actual value (for a specific duration) of a KPI: The value computed for the KPI based on the measured data for that specific duration.

Projected value (for a specific duration) of a KPI: The predicted value of the KPI that is computed based on various prior data. The projected value can be determined using any combination or individual ones of techniques such as modeling the KPI using a forecasting model, Artificial Intelligence, Machine Learning, or by any simple mathematical model. The projected value may thus be understood encompass terms such as expected value or forecasted value well known in the relevant arts.

Deviation: The magnitude by which a projected value of a KPI in a specific time duration differs from the corresponding actual value for the time duration.

### 2. Overview

A BI system provided according to an aspect of the present disclosure identifies key performance indicators (KPIs) of interest for a given time duration without requiring any user inputs for such purpose. In other words, the user may provide inputs for purposes such as specifying the time duration, for initiation of execution of modules to trigger the identification, etc., but no user inputs may be required for such identification itself.

In an embodiment, the KPIs of interest are determined by examining a corresponding sequence of measurements for each key performance indicator (KPI). The KPIs thus identified are sent for display.

According to another aspect, each KPI is determined to be of interest or not, based on a deviation of an actual value from a projected value for the given time duration. In an embodiment, a first range for deviation of the actual value from the projected value is computed in relation to a first KPI for the given time duration based on the corresponding deviation between the actual value and the projected value in a sequence of time durations for the first KPI. The first KPI is included in the set of KPIs if the computed deviation (of actual value from projected value) is outside of the first range for the first KPI.

In a further embodiment, upper and lower limits are calculated based on the projected value and positive/negative thresholds, and the first KPI is included in the set of KPIs if the actual value of the first KPI is less than the lower limit or greater than the upper limit for the first KPI. The KPIs in the set may be sorted according to deviation scores computed for the KPIs, and the KPIs deviating more are considered as having more pertinent information.

According to one more aspect, respective sets of KPIs are identified for each of a set of time durations, wherein the sets of KPIs are sent for display associated with respective set of time durations.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 3. Example Environment

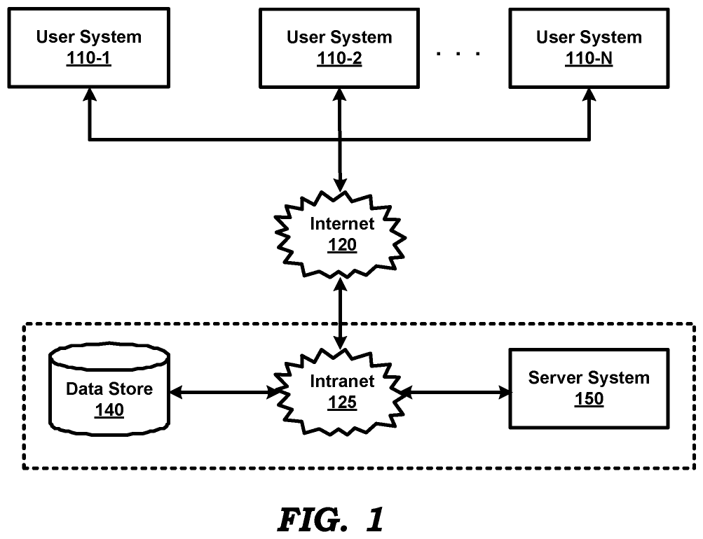

FIG. 1 is a block diagram illustrating an example environment (computing system) in which several aspects of the present disclosure can be implemented. The block diagram is shown containing user systems 110-1 to 110-N, internet 120, intranet 125, server system 150 and data store 140. User systems 110-1 to 110-N are collectively or individually referred by referral numeral 110, as will be clear from the context.

Merely for illustration, only representative number/type of blocks is shown in FIG. 1. Many environments often contain many more blocks, both in number and type, depending on the purpose for which the environment is designed. Specifically, many instances of server system 150 and data store 140 may be present in the computing system. Each block of FIG. 1 is described below in further detail.

Internet 120 represents a data network providing connectivity between user systems 110-1 to 110-N and server system 150. Internet 120 may encompass the world-wide connected Internet. Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by internet 120. When the packet contains content such as port numbers, which specifies an internal component such as target application and/or internal system, the packet may be directed to such application or internal system as well.

Intranet 125 provides connectivity between data store 140 and server system 150, in addition to extending connectivity via Internet 120. Intranet 125 may be implemented using any combination of wire-based or wireless mediums.

Data store 140 represents a non-volatile (persistent) storage facilitating storage and retrieval of a collection of time series of measurements in a BI system. The time series of measurements is a set of chronologically ordered data points and may be based on different grains such as seconds, hours, daily, weekly, quarterly, etc. as is well known in the relevant arts. Data in data store 140 may be organized using any combination of relational, hierarchical, network, etc., type models as is well known in the relevant arts.

In an embodiment, data store 140 represents a data warehouse storing a large collection of time series of measurements with the corresponding schema, e.g. star schema, snowflake schema. It may be appreciated that transaction systems such as relational databases may collect data at smaller grains (e.g., with a simple time stamp, or based on short durations such as days), while the data aggregated at larger grains (weeks, months, years, etc.) is stored in the data warehouse, as is well known in the relevant arts. The data warehouse provides commands (e.g., rollup) to aggregate data easily and quickly at even higher grains.

Server system 150 represents a server, such as a web/application server, executing one or more software applications such as ERP, CRM, BI applications, etc. Server system 150 may provide suitable interfaces for user systems 110 to access such applications. Many instances of server system 150 and data store 140 may be provided in a cloud infrastructure.

Each of user systems 110-1 to 110-N represents a system such as a personal computer, workstation, mobile device, computing tablet, etc., used by end users. User system 110 may be used by persons such as high level executives for examination of various KPIs of interest notified by server system 150. However, as noted above, it is often a challenge to decide which of the many KPIs would be of particular interest.

An aspect of the present disclosure automatically identifies KPIs of particular relevance or interest for a specific duration or a set of durations, and notifies the same to a user. In other words, the set of relevant KPIs for a first time duration can be different from that for a second time duration depending on the values of the data in pertinent durations. Accordingly, business executives may be provided the most pertinent KPIs that need to be examined given (e.g., specified by a user) a specific duration (e.g., a month) of interest. The manner in which most pertinent KPIs for a given (e.g., specified by an executive or programmatically determined when a corresponding date on a calendar is reached) duration may be identified is described below with examples.

### 4. Flowchart

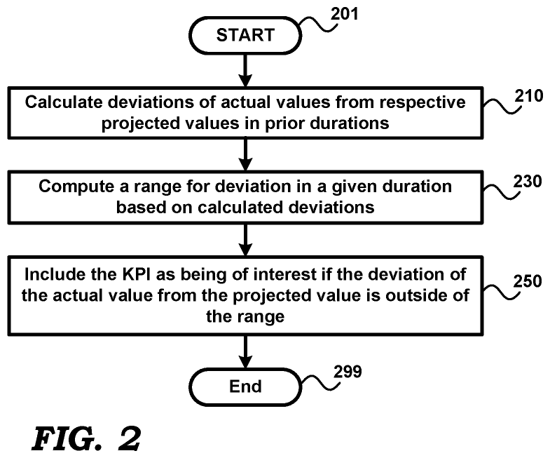

FIG. 2 is a flowchart illustrating the manner in which KPIs of interest in a BI system are identified for a given duration. The flowchart is described with respect to server system 150 of FIG. 1 merely for illustration. However, many of the features can be implemented in other systems (e.g., user systems 110) and/or other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, server system 150 calculates deviations of actual values from respective projected values in prior (compared to given duration) durations for a KPI. As may be readily appreciated, the KPI would have a specific respective actual value and projected value for each of a set of prior durations in time series. The time duration may be specified by a user or server system 150 may be pre-configured to automatically identify the KPIs of interest at a certain frequency (e.g. monthly or quarterly when the data is available, etc.) for notification in accordance with the features of the present disclosure. Thus, for each of such prior durations (relative to the given duration), a deviation may be calculated. Control passes to step 230.

In step 230, server system 150 computes a range for deviation in the given duration based on deviations calculated in step 210. The range can be expressed based on a positive threshold and a negative threshold (around the actual/projected value), even though the embodiments described below use the same absolute value for both the thresholds. Control passes to step 250.

In step 250, server system 150 includes the KPI as being of interest in the given time duration if the deviation of the actual value from the projected value in the given time duration is outside of the range computed in step 230. The flowchart thereafter ends in step 299.

Server system 150 repeats steps 210-250 for all KPIs in the BI system to identify all KPIs of interest. Server system 150 thereafter notifies the sets of KPIs by forwarding the set for display on user system 110. The display indicates that those KPIs can be further investigated for actionable items.

Such set of KPIs are determined to be of interest based on an observation that the more a KPI deviates from the range computed in step 230 based on its past record, the more is the relevance of information content of the KPI. If a KPI is performing as per the projection, an extensive analysis may not be required for the KPI and thus the KPI may not be of particular interest.

It may thus be appreciated that the set of KPIs of interest for a given duration are identified without requiring user input for that purpose. The user may at best need to specify the given duration and initiate execution of the general task of identification, but such user inputs are not provided for the purpose of identification of the set of KPIs.

The manner in which such features are implemented in an example embodiment is described below in further detail.

### 5. Projected Values

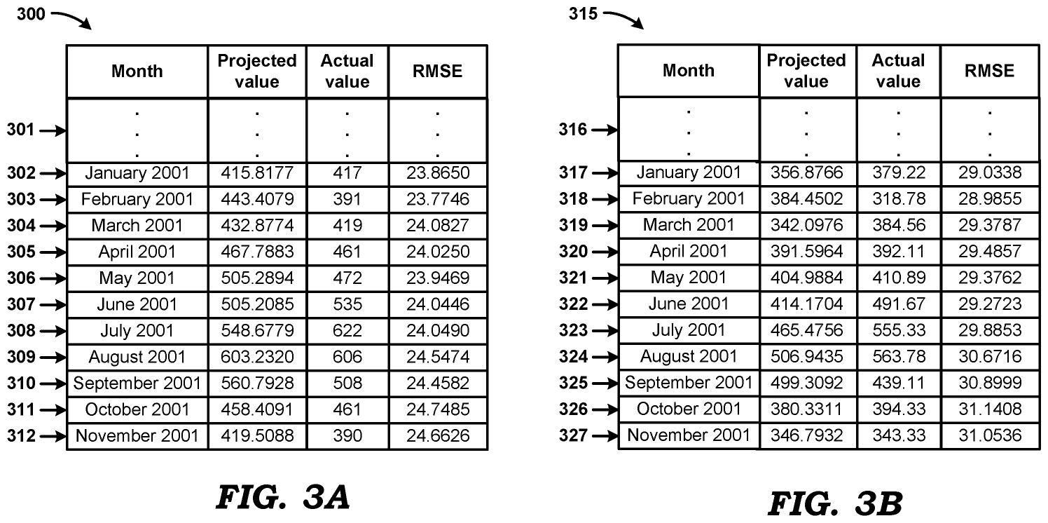

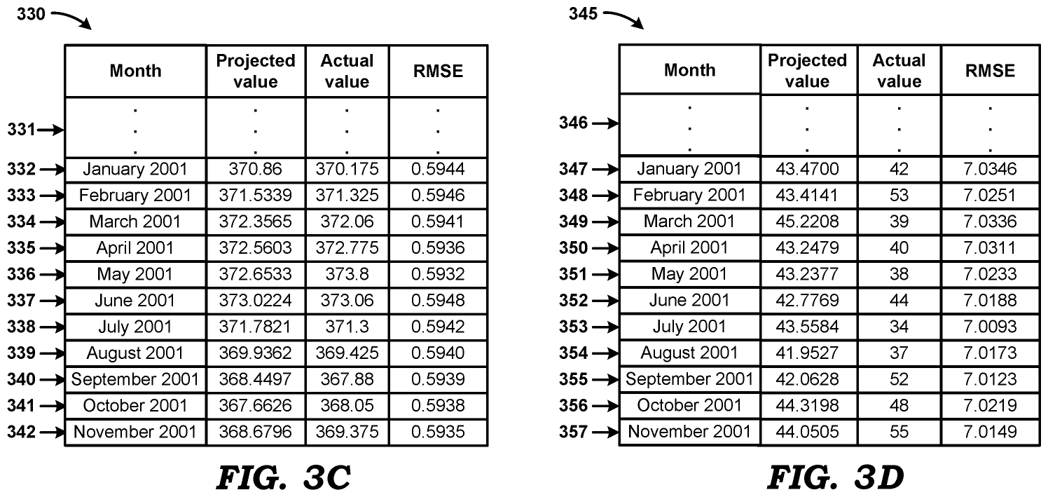

FIGS. 3A-3D depict sample projected values for four KPIs in a BI system based on a time series of measurements over a long duration, assuming the given month of interest is November 2001. The time series of measurements is assumed to be stored in a data warehouse for the illustrative embodiment. The data corresponding to the KPI of FIG. 3A is shown in Appendix A. The data for other KPIs is not included here in the interest of conciseness. Although Appendix A is shown containing measurements for KPI “number of customers” for months January 1990 to December 2001, it may be readily appreciated that the measurements can span longer durations and the grain at which the data is collected may vary (e.g. hour, day, week, etc.).

Only some of the fields, as relevant to an understanding of the disclosure, are depicted in the Figure for conciseness. There will be many more KPIs in a BI system as will be apparent to a person skilled in the art. Although the illustrative embodiment is described with respect to KPIs based on monthly grain, any suitable time grain may be selected for KPI analysis as will also be apparent to a person skilled in the relevant art.

FIG. 3A depicts sample projected values for KPI “number of customers” for the months January-November, 2001. Specifically, table 300 is shown containing 12 rows [301-312]. Row 301 indicates that the data shown in table 300 is a continuation of values computed in durations prior to January 2001, based on the measurements in Appendix A. Similar convention is followed in other Figures to indicate continuity of calculations from prior durations.

Column “Month” specifies the month for which the projected value is computed and the actual value is available. Column “Projected value” specifies the projected value of number of customers for the month. Column “Actual value” specifies the actual value of number of customers for the month. Column “RMSE” specifies the root mean square error for the previous months.

In an embodiment, RMSE in any row is calculated as the square root of the average of squared errors of all prior time durations (i.e., before the row in the tables). An error for a time duration is the difference between the projected value for that time duration and the respective actual value. RMSE specifies the error of a forecasting model in predicting values or in other words standard deviation of the residuals. As can be readily observed, RMSE values in FIGS. 3A-3D are computed based on the data not shown in the corresponding tables.

It may be appreciated that the actual value of a KPI may be directly available as a measurement in the time series or may be computed from the corresponding base measurements (of lower grain) available in the data warehouse.

FIG. 3B depicts sample projected values for KPI “monthly profit” for the months January-November, 2001. Specifically, table 315 is shown containing 11 rows [316-327]. Columns “Month”, “Projected value”, “Actual value” and “RMSE” respectively specify the corresponding columns as in FIG. 3A and are not repeated here for conciseness. Columns “Projected value”, “Actual value” and RMSE are specified in million USD.

FIG. 3C depicts sample projected values for KPI “monthly investment” for the months January-November, 2001. Specifically, table 330 is shown containing 11 rows [331-342]. Columns “Month”, “Projected value”, “Actual value” and “RMSE” respectively specify the corresponding columns as in FIG. 3A and are not repeated here for conciseness. Columns “Projected value”, “Actual value” and RMSE are specified in million USD.

FIG. 3D depicts sample projected values for KPI “new customers” for the months January-November, 2001. The KPI “new customers” specifies the number of customers added for a newly launched product. Specifically, table 345 is shown containing 11 rows [346-357]. Columns “Month”, “Projected value”, “Actual value” and “RMSE” respectively specify the corresponding columns as in FIG. 3A and are not repeated here for conciseness. It may be noted that the data for “monthly profit” and “monthly investment” relate to different scenarios, though shown as being for the same time durations.

In the illustrative embodiment, Auto Regressive Integrated Moving Average (ARIMA) model with suitable parameters has been used to compute the projected values. However, alternative ways of computing projected values will be apparent to a skilled practitioner without departing from the scope and spirit of several aspects of the present invention, by reading the present disclosure.

The description is continued with respect to the manner in which server system 150 uses such time series of measurements to identify whether or not each KPI is of interest, in an embodiment of the present disclosure.

### 6. Calculations for Identification of KPIs of Interest in Time Durations

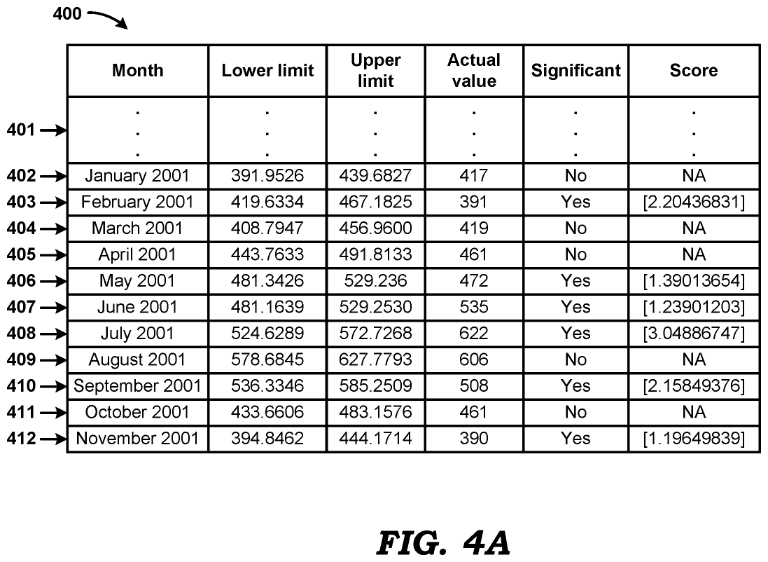

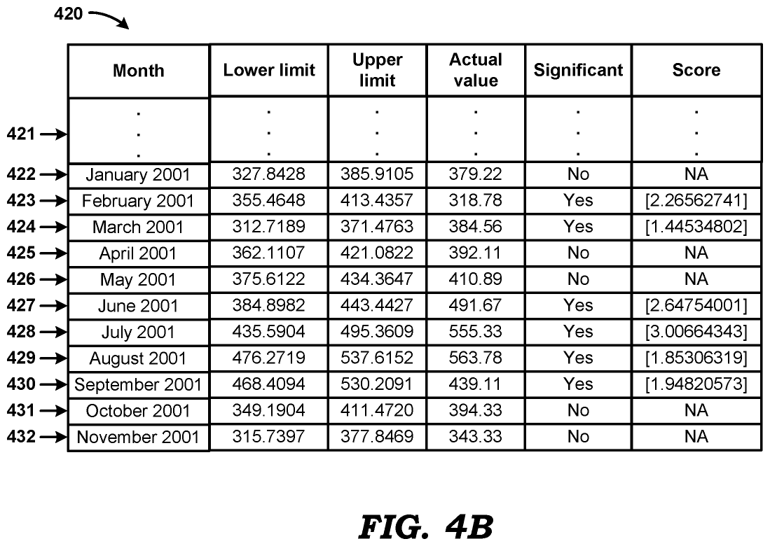

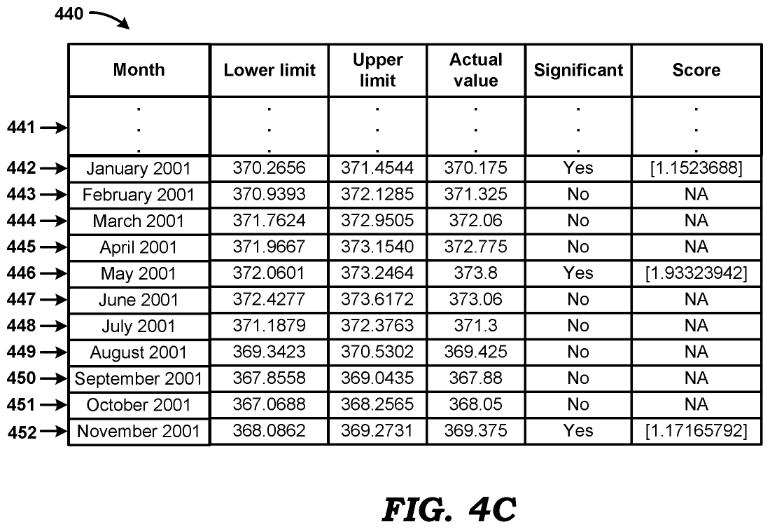

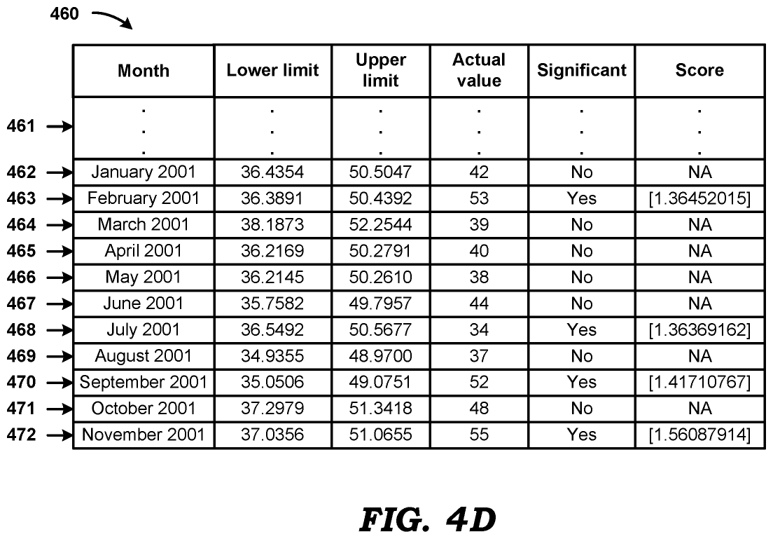

FIGS. 4A-4D depict respective tables which depict whether or not a corresponding KPI is of interest (significant) in each of a sequence of time durations. Each row of the tables depicts whether or not the corresponding KPI is of interest for the specific time duration (assuming such time duration is the given time duration).

Specifically, FIG. 4A depicts the various inputs and outputs in determining whether or not the KPI “number of customers” is of interest for each of the months January-November 2001. Specifically, table 400 is shown containing 12 rows [401-412].

Column “Month” specifies the month for which the projected value is computed and the actual value is available. Column “Lower limit” specifies a lower boundary of the computed range. Column “Upper limit” specifies an upper boundary of the computed range. Column “Actual value” specifies the actual value of number of customers for the month. Column “Significant” specifies if the KPI for the month is of interest. A value of “Yes” in the column indicates that the corresponding KPI for the month is of interest and “No” denotes otherwise. Column “Score” specifies a quantity computed for the KPI for the month based on the deviation of actual value from respective projected value for that month.

FIG. 4B depicts similar information for the KPI “monthly profit”. Specifically, table 420 is shown containing 12 rows [421-432]. Columns “Month”, “Lower limit”, “Upper limit”, “Actual value”, “Significant” and “Score” respectively specify the corresponding columns as in FIG. 4A and are not repeated here for conciseness. Columns “Lower limit”, “Upper limit” and “Actual value” are specified in million USD.

FIG. 4C depicts similar information for the KPI “monthly investment” for the months January-November, 2001. Specifically, table 440 is shown containing 12 rows [441-452]. Columns “Month”, “Lower limit”, “Upper limit”, “Actual value”, “Significant” and “Score” respectively specify the corresponding columns as in FIG. 4A and are not repeated here for conciseness. Columns “Lower limit”, “Upper limit” and “Actual value” are specified in million USD.

FIG. 4D depicts similar information for the KPI “new customers” for the months January-November, 2001. Specifically, table 460 is shown containing 12 rows [461-472]. Columns “Month”, “Lower limit”, “Upper limit”, “Actual value”, “Significant” and “Score” respectively specify the corresponding columns as in FIG. 4A and are not repeated here for conciseness.

Server system 150 computes a range for deviations for each KPI for a given time duration based on calculated deviations. In an embodiment, the range for the given time duration is defined by an upper limit and a lower limit computed by server system 150 as follows:

Deviation=Projected value of the KPI for the given time duration−Actual value of the KPI for the given time duration

Range=Negative threshold to Positive threshold

Lower limit=Projected value of the KPI for the given time duration−Negative threshold

Upper limit=Projected value of the KPI for the given time duration+Positive threshold

In an embodiment, the positive threshold equals the negative threshold and is equal to the RMSE for the previous time duration. However, alternative ways of computing thresholds and corresponding limits will be apparent to a skilled practitioner without departing from the scope and spirit of several aspects of the present invention, by reading the present disclosure.

Thus, in the illustrative embodiment, server system 150 computes the limits for a given month as:

Lower limit=Projected value of KPI for that month−RMSE for the previous months

Upper limit=Projected value of KPI for that month+RMSE for the previous months

Specifically, referring to row 312 in FIG. 3A, the error for the month of November 2001 for the KPI “number of customers” is:

Error=Projected value−Actual value=419.5088−390=29.5088

Errors are computed similarly for previous durations.

RMSE for row 312 is calculated as square root of average of squared errors for all prior months (for which the data is available, as shown in Appendix A) up to October 2001 but excluding November 2001 in the example approach herein.

Thus, RMSE for row 312 is calculated as 24.6626. RMSE is computed similarly for other rows.

Referring to row 412 in FIG. 4A together with row 312 of FIG. 3A,

Lower limit=419.5088−24.6626=394.8462

Upper limit=419.5088+24.6626=444.1714

Server system 150 continues in the above manner and computes the limit for deviations for each month, as depicted in tables 400, 420, 440 and 460.

In an alternative scenario, the range for deviations may be computed and output by the forecasting model based on a confidence interval (CI) value. In such a scenario, the user specifies a confidence level (e.g., 95%) for the model and the forecasting model computes/evaluates the forecasted/projected value for the period of interest based on which upper and lower limits are computed. ARIMA model, well known in the relevant arts, is an example approach for such a computation. Based on the limits thus computed, server system 150 or user system 110 may directly identify KPIs of interest based on comparison of the actual values with the limits.

The description is continued with respect to the manner in which server system 150 identifies KPIs of particular interest for the month of November 2001 (potentially soon after data for November 2001 is available) in accordance with features of the present disclosure.

### 7. Identifying KPIs of Interest Based on Calculated Ranges

As noted above, server system 150 includes a KPI as being of interest if the deviation of the actual value from the projected value is outside of the computed range for the month of November 2001.

For example, referring to row 412 of FIG. 4A together with row 312 of FIG. 3A, for the KPI “number of customers”:

Range=−24.6626 to +24.6626

Lower limit=394.8462

Upper limit=444.1714

Actual value=390

Projected value=419.5088

Deviation=419.5088−390=29.5088

Server system 150 identifies that the deviation is outside of the range and therefore concludes that the KPI is of interest. Server system 150 marks a “Yes” in column “Significant” in row 412.

Similarly, referring to row 432 of FIG. 4B, for the KPI “monthly profit”:

Lower limit=315.7397

Upper limit=377.8469

Actual value=343.33

Server system 150 identifies that the actual value is within the limits and therefore concludes that the KPI is not of interest. Server system 150 marks a “No” in column “Significant” in row 432.

Continuing thus, server system 150 identifies the following KPIs as being of interest in the month of November 2001:

“Number of customers”,

“Monthly investment” and

“New customers”

It may be appreciated that when a particular KPI is identified as being of interest in a given time duration, it may warrant further investigation for that time duration. For example, KPI of interest “new customers” in November 2001 may indicate to a business executive that further investigation of the KPI is required. Upon further investigation, it may be observed that the actual value of new customers is greater than the upper limit in November 2001 [row 472 of FIG. 4D]. Since the KPI represents the number of customers added for a newly launched product, the business executive may infer that the newly launched product has done well beyond expectation based on previous trend in the market and may accordingly plan to increase the corresponding production of the new products.

Similarly, when the business executive investigates the KPI of interest “number of customers” in November 2001, it may be observed that the number of customers is lesser than the lower limit [row 412 of FIG. 4A]. This may indicate to the business executive that a corrective course of action is required for customer retention.

It may be appreciated that a business executive may select any past time duration as well in order to identify the KPIs of interest during the past time duration. For example, a business executive may want to identify KPIs of interest in April 2001, which is the beginning of a quarter of the year. Server system 150 would then compute the deviations and ranges for all months up to April 2001 and present the KPIs of interest to the business executive.

In some embodiments, in addition to identifying KPIs of interest, it may be desirable to compute a corresponding score for each KPI of interest to indicate the extent of relevance of the KPI. The KPIs of interest may then be presented to the end user in the relative order of significance based on the score.

The manner in which KPIs of interest are ranked in an embodiment is described below.

### 8. Ranking KPIs of Interest

In an embodiment, server system computes a score for each KPI of interest for a given time duration based on the formula:

Score={absolute(projected value−actual value)}/RMSE; the projected value and actual value are for the given time duration and RMSE is for the previous time duration based on actual and projected values.

For example, turning to FIG. 4A, server system 150 computes the score for the KPI “number of customers” for November 2001 as:

Score={absolute(419.5088−390)}/24.6626=1.1964

As another example, referring to row 452 of FIG. 4C together with row 342 of FIG. 3C, the score for the KPI “monthly investment” for November 2001 is:

Score={absolute(368.6796−369.375)}/0.5935=1.1716

It may be appreciated that server system 150 does not compute a score for the KPI “monthly profit” for the month of November 2001 as the KPI has not been identified as being of interest.

Server system 150 continues in the above manner and computes score for each KPI of interest in the month of November 2001.

It may be appreciated that the above approach is one of the ways of computing score for KPIs of interest. However, alternative ways of computing scores will be apparent to a skilled practitioner without departing from the scope and spirit of several aspects of the present invention, by reading the present disclosure. For example, standard deviation value may be used to compute the score as is well known in the relevant arts.

In addition, if the causals for the KPI are available as a time series data, those attributes or causals can also be used to validate their impacts on those KPI's. When this level of data is available, the KPI ranking can be derived by various causal forecasting modelling techniques like deterministic or Bayesian Least Square, Kalman Filter or Neural Network based (E.g. LSTM) approaches depending upon the nature of the data.

Server system 150 may forward the KPIs of interest and the respective scores to user system 110 for display for the given time duration, thus notifying business executives.

In certain scenarios, a very high score for a KPI of interest may indicate that the KPI contains extremely significant information and needs immediate attention of the high level executives.

The description is continued below to illustrate such a scenario with respect to sample data in a second time duration, having an extension to the first time duration.

### 9. Illustration of Large Deviation in KPI of Interest

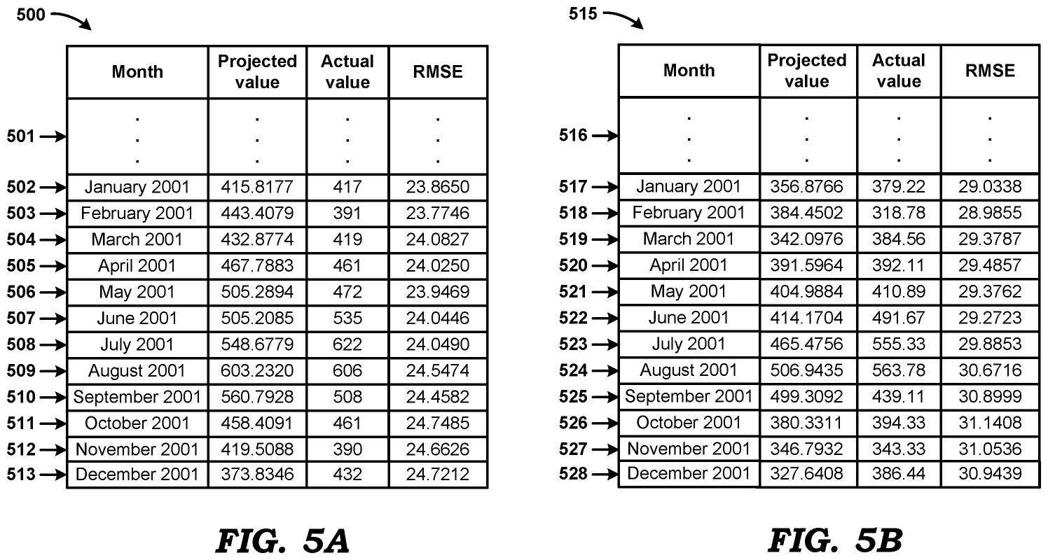

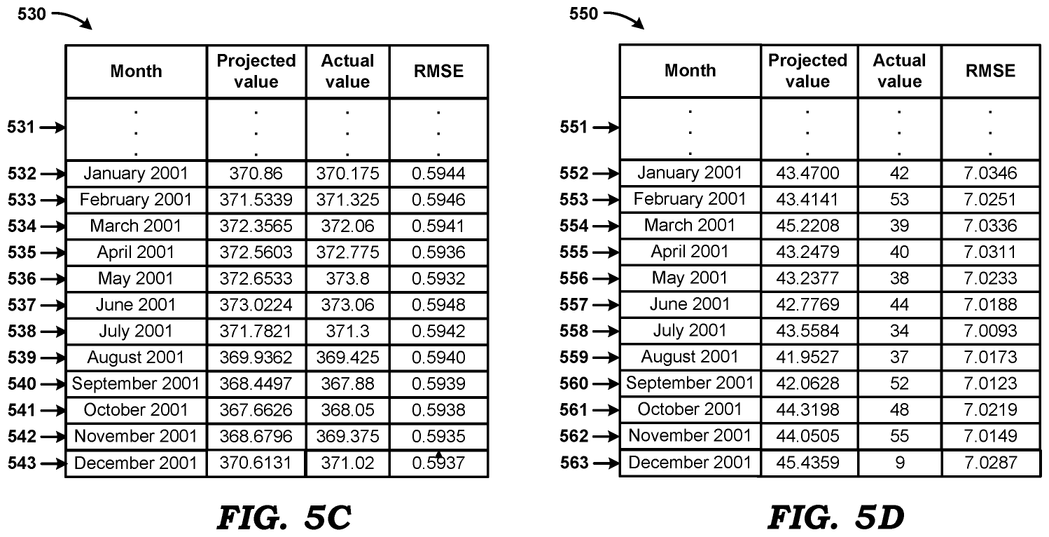

FIGS. 5A-5D depict sample projected values for the illustrative KPIs for a second time duration, having an extension to the first time duration. Specifically, a row has been added in each table (of tables in FIGS. 3A-3D) for the data pertaining to the month of December 2001. Thus, table 500 in FIG. 5A is shown containing 13 rows [rows 501-513] for KPI “number of customers”, table 515 in FIG. 5B is shown containing 13 rows [rows 516-528] for KPI “monthly profit”, table 530 in FIG. 5C is shown containing 13 rows [rows 531-543] for KPI “monthly investment” and table 550 in FIG. 5D is shown containing 13 rows [rows 551-563] for KPI “new customers”.

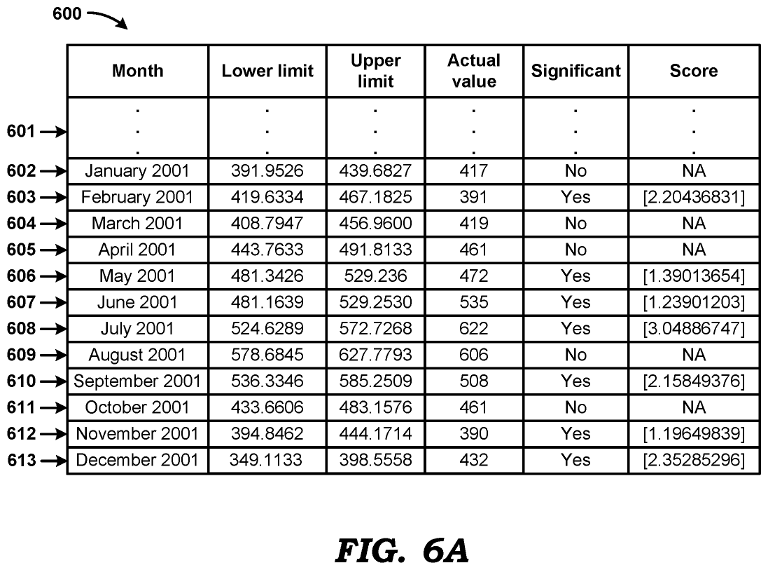

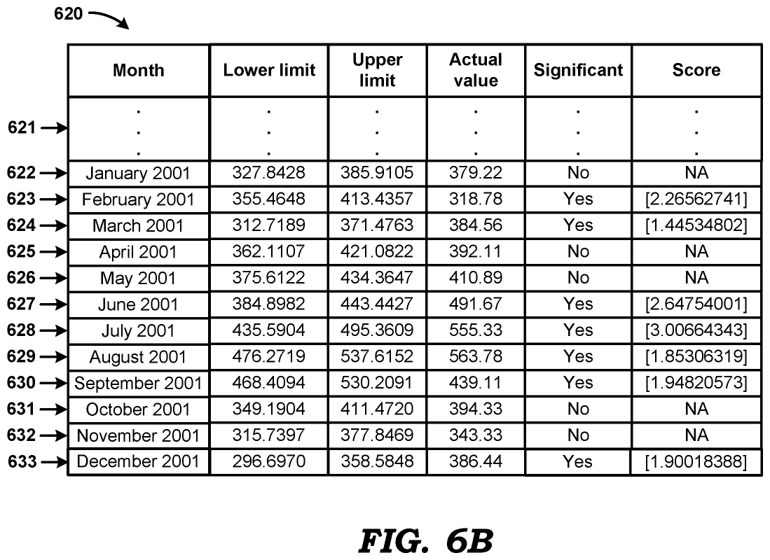

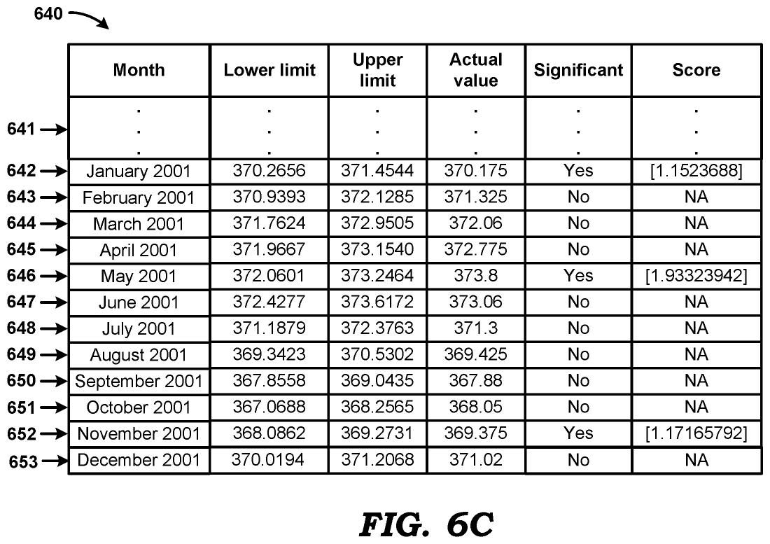

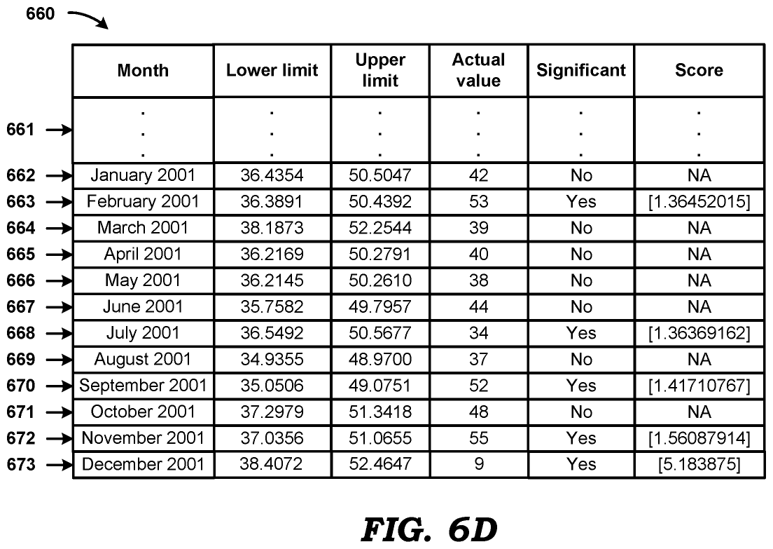

FIGS. 6A-6D depict inputs and outputs for identifying the illustrative KPIs of interest for the second time duration. Specifically, a row has been added in each table (of tables in FIGS. 4A-4D) for the data pertaining to the month of December 2001. Thus, table 600 in FIG. 6A is shown containing 13 rows [rows 601-613] for KPI “number of customers”, table 620 in FIG. 6B is shown containing 13 rows [rows 621-633] for KPI “monthly profit”, table 640 in FIG. 6C is shown containing 13 rows [rows 641-653] for KPI “monthly investment” and table 660 in FIG. 6D is shown containing 13 rows [rows 661-673] for KPI “new customers”.

As described above with respect to the month of November 2001, server system 150 now identifies KPIs of interest for the month of December 2001 and computes respective scores.

Specifically, in this second illustration, server system 150 identifies KPIs “number of customer”, “monthly profit” and “new customers” as being of interest and computes the respective scores as 2.3528, 1.9 and 5.18 respectively.

The high deviation value for KPI “new customers” may indicate to a business executive that further investigation is required. Upon further investigation [row 673 of FIG. 6D], it is observed that the actual value, 9, of new customers is far below the lower limit of 38.4072. Thus, the business executive may need to take corrective course of action for customer acquisition.

In this manner, server system 150 identifies and ranks KPIs of particular interest in a BI system and all such KPIs may be suitably communicated via a dashboard for convenient viewing by a high level executive as described below.

### 10. Sample BI Dashboards

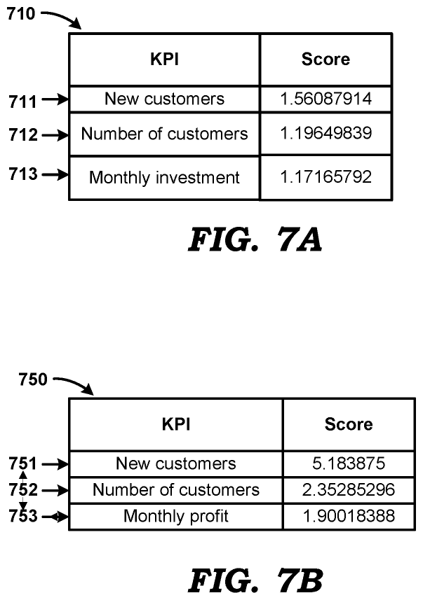

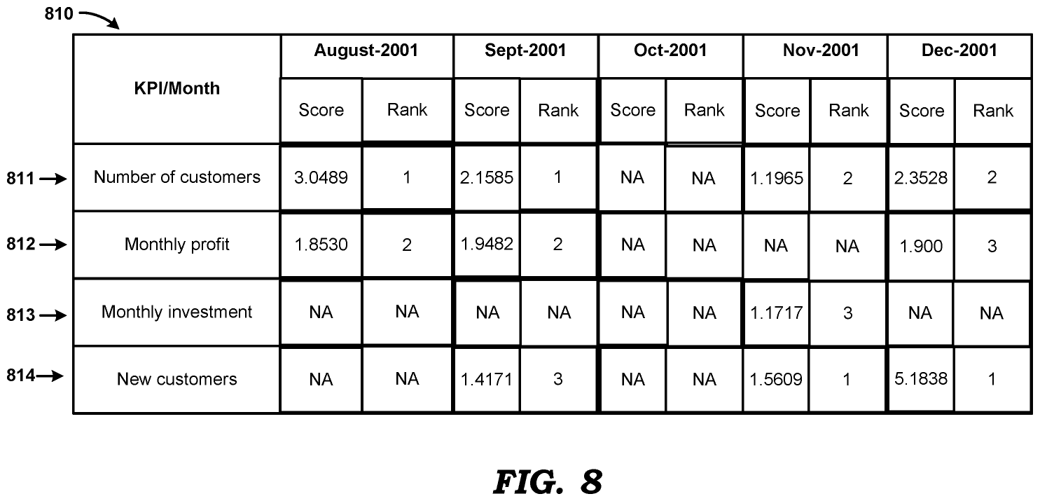

FIGS. 7A-7B depict sample dashboards displayed by server system 150 on user system 110.

The dashboard of FIG. 7A is shown containing the KPIs of interest in the month of November 2001, sorted in descending order of corresponding scores. Specifically, table 710 is shown containing 3 rows [711-713]. KPI “new customers” is shown in the first row as it has the highest score among the KPIs of interest. It may be observed that KPI “monthly profit” is not displayed on the dashboard as it is not considered to be of interest. The actual value of monthly profit in the month of November 2001 is not outside of the calculated limits.

The dashboard of FIG. 7B is shown containing the KPIs of interest in the month of December 2001, sorted in descending order of corresponding scores. Specifically, table 750 is shown containing 3 rows [751-753]. KPI “new customers” is shown in the first row as it has the highest score among the KPIs of interest. It may be observed that KPI “monthly investment” is not displayed on the dashboard as it is not considered to be of interest. The actual value of monthly investment in the month of December 2001 is not outside of the calculated limits.

It may be appreciated that the BI dashboard only shows the KPIs of interest, thus enabling the business executives to focus on the significant KPIs.

In alternative embodiments, the dashboard may display all the KPIs for a time duration but may display the KPIs of interest on the top in order of their respective scores.

In yet another alternative embodiment, it may be helpful to summarize KPI data over a sequence of time durations for identifying the performance trend of KPIs by business executives.

In such an embodiment, the dashboard may display all KPIs for a sequence of time durations, as described in the below example.

### 11. Displaying KPIs of Interest Over a Sequence of Time Durations

FIG. 8 depicts sample BI dashboard displayed to end user for the months August-December 2001. Table 810 is shown containing 4 rows [811-814] with each row corresponding to one of the four illustrative KPIs. Column “Score” for each month specifies the score computed for the KPI by server system 150 as described above in great detail. Column “Rank” specifies the ranking of the KPI relative to other KPIs for the time duration. A value of “NA” in a column indicates that server system 150 has not identified the KPI as being of interest (actual value of the KPI is within the computed limits) and hence has not computed a score for the KPI.

As can be readily observed from row 814, the KPI “new customers” is ranked low in the month of September 2001 and hence may not be a subject of extensive analysis by a high level executive. However, in the months of November and December 2001, the KPI is ranked 1. Thus, as noted earlier, this may prompt the high level executive to do further analysis for the KPI and take action, if required.

It may be appreciated that there may be a large number of KPIs in an organization with each KPI giving information about a different aspect of the business for the time duration in question. Analyzing each and every KPI in the business may become cumbersome and complicated. When a set of KPIs of interest containing pertinent information is notified to the end user, it aids a focused approach for further analysis for actionable items of the corresponding KPI.

In addition, it may be appreciated that the features of the present disclosure can be operative in conjunction with (specifically as a precursor to) approaches which automatically determine dimensions of interest (for example, as described in the RELATED APPLICATION noted above). Accordingly, both KPIs of interest and the relevant dimensions in each KPI may be automatically determined and made available in a dashboard according to aspects of the present disclosure.

It may be further appreciated the features described herein can be implemented in individual ones or combination of user systems 110 and server system 150, and a BI system may be viewed as encompassing any of each of such implementations. It should be also appreciated that the features described above can be implemented in various embodiments as a desired combination of one or more of hardware, software, and firmware. The description is continued with respect to an embodiment in which various features are operative when the software instructions described above are executed.

### 12. Digital Processing System

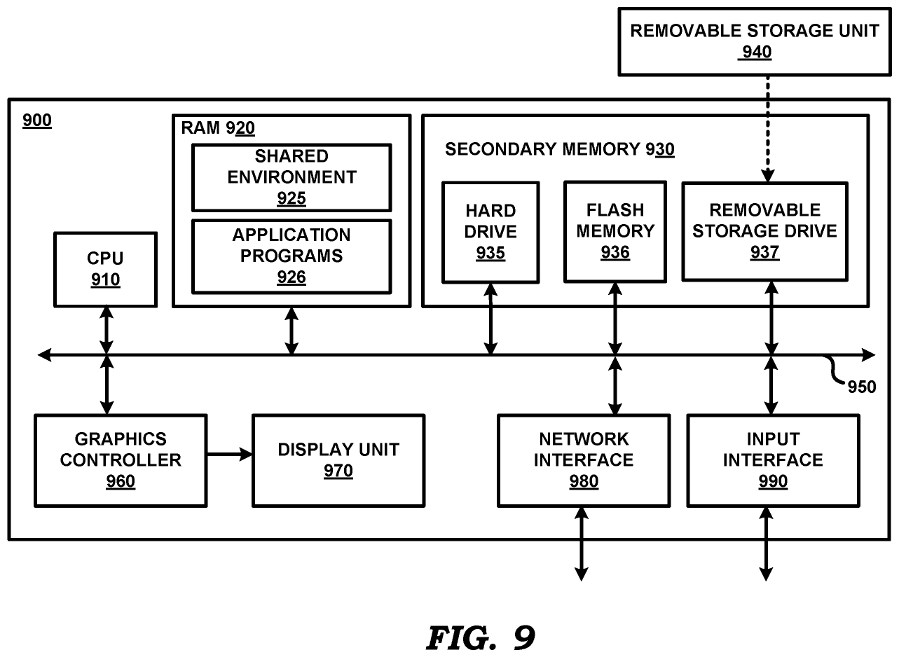

FIG. 9 is a block diagram illustrating the details of digital processing system 900 in which various aspects of the present disclosure are operative by execution of appropriate executable modules. Digital processing system 900 may correspond to one of user system 110 or server system 150 as a part of a BI system.

Digital processing system 900 may contain one or more processors such as a central processing unit (CPU) 910, random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present disclosure. CPU 910 may contain multiple processing units, with each processing unit potentially being designed for a specific task. Alternatively, CPU 910 may contain only a single general-purpose processing unit.

RAM 920 may receive instructions from secondary memory 930 using communication path 950. RAM 920 is shown currently containing software instructions constituting shared environment 925 and/or other user programs 926. Shared environment 925 contains software programs such as device drivers, operating systems, virtual machines, containers, etc., which provide a (shared) run time environment for execution of other/user programs.

Graphics controller 960 generates display signals (e.g., in RGB format) to display unit 970 based on data/instructions received from CPU 910. Display unit 970 contains a display screen to display the images (e.g., dashboard of FIGS. 7A-7B and FIG. 8) defined by the display signals. Input interface 990 may correspond to a keyboard and a pointing device (e.g., touch-pad, mouse) and may be used to provide inputs. Network interface 980 provides connectivity to a network (e.g., using Internet Protocol), and may be used to communicate with data store 140 (of FIG. 1) connected to the networks (120).

Secondary memory 930 may contain hard drive 935, flash memory 936, and removable storage drive 937. Secondary memory 930 may store the data (for example, data portions shown in FIGS. 3A-3D) and software instructions (for example, for implementing the various features of the present disclosure as shown in FIG. 2, etc.), which enable digital processing system 900 to provide several features in accordance with the present disclosure. The code/instructions stored in secondary memory 930 may either be copied to RAM 920 prior to execution by CPU 910 for higher execution speeds, or may be directly executed by CPU 910.

Some or all of the data and instructions may be provided on removable storage unit 940, and the data and instructions may be read and provided by removable storage drive 937 to CPU 910. Removable storage unit 940 may be implemented using medium and storage format compatible with removable storage drive 937 such that removable storage drive 937 can read the data and instructions. Thus, removable storage unit 940 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 940 or hard disk installed in hard drive 935. These computer program products are means for providing software to digital processing system 900. CPU 910 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 930. Volatile media includes dynamic memory, such as RAM 920. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 950. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 13. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

| Month | Number of customers |
|---|---|
| January 1990 | 112 |
| February 1990 | 118 |
| March 1990 | 132 |
| April 1990 | 129 |
| May 1990 | 121 |
| June 1990 | 135 |
| July 1990 | 148 |
| August 1990 | 148 |
| September 1990 | 136 |
| October 1990 | 119 |
| November 1990 | 104 |
| December 1990 | 118 |
| January 1991 | 115 |
| February 1991 | 126 |
| March 1991 | 141 |
| April 1991 | 135 |
| May 1991 | 125 |
| June 1991 | 149 |
| July 1991 | 170 |
| August 1991 | 170 |
| September 1991 | 158 |
| October 1991 | 133 |
| November 1991 | 114 |
| December 1991 | 140 |
| January 1992 | 145 |
| February 1992 | 150 |
| March 1992 | 178 |
| April 1992 | 163 |
| May 1992 | 172 |
| June 1992 | 178 |
| July 1992 | 199 |
| August 1992 | 199 |
| September 1992 | 184 |
| October 1992 | 162 |
| November 1992 | 146 |
| December 1992 | 166 |
| January 1993 | 171 |
| February 1993 | 180 |
| March 1993 | 193 |
| April 1993 | 181 |
| May 1993 | 183 |
| June 1993 | 218 |
| July 1993 | 230 |
| August 1993 | 242 |
| September 1993 | 209 |
| October 1993 | 191 |
| November 1993 | 172 |
| December 1993 | 194 |
| January 1994 | 196 |
| February 1994 | 196 |
| March 1994 | 236 |
| April 1994 | 235 |
| May 1994 | 229 |
| June 1994 | 243 |
| July 1994 | 264 |
| August 1994 | 272 |
| September 1994 | 237 |
| October 1994 | 211 |
| November 1994 | 180 |
| December 1994 | 201 |
| January 1995 | 204 |
| February 1995 | 188 |
| March 1995 | 235 |
| April 1995 | 227 |
| May 1995 | 234 |
| June 1995 | 264 |
| July 1995 | 302 |
| August 1995 | 293 |
| September 1995 | 259 |
| October 1995 | 229 |
| November 1995 | 203 |
| December 1995 | 229 |
| January 1996 | 242 |
| February 1996 | 233 |
| March 1996 | 267 |
| April 1996 | 269 |
| May 1996 | 270 |
| June 1996 | 315 |
| July 1996 | 364 |
| August 1996 | 347 |
| September 1996 | 312 |
| October 1996 | 274 |
| November 1996 | 237 |
| December 1996 | 278 |
| January 1997 | 284 |
| February 1997 | 277 |
| March 1997 | 317 |
| April 1997 | 313 |
| May 1997 | 318 |
| June 1997 | 374 |
| July 1997 | 413 |
| August 1997 | 405 |
| September 1997 | 355 |
| October 1997 | 306 |
| November 1997 | 271 |
| December 1997 | 306 |
| January 1998 | 315 |
| February 1998 | 301 |
| March 1998 | 356 |
| April 1998 | 348 |
| May 1998 | 355 |
| June 1998 | 422 |
| July 1998 | 465 |
| August 1998 | 467 |
| September 1998 | 404 |
| October 1998 | 347 |
| November 1998 | 305 |
| December 1998 | 336 |
| January 1999 | 340 |
| February 1999 | 318 |
| March 1999 | 362 |
| April 1999 | 348 |
| May 1999 | 363 |
| June 1999 | 435 |
| July 1999 | 491 |
| August 1999 | 505 |
| September 1999 | 404 |
| October 1999 | 359 |
| November 1999 | 310 |
| December 1999 | 337 |
| January 2000 | 360 |
| February 2000 | 342 |
| March 2000 | 406 |
| April 2000 | 396 |
| May 2000 | 420 |
| June 2000 | 472 |
| July 2000 | 548 |
| August 2000 | 559 |
| September 2000 | 463 |
| October 2000 | 407 |
| November 2000 | 362 |
| December 2000 | 405 |
| January 2001 | 417 |
| February 2001 | 391 |
| March 2001 | 419 |
| April 2001 | 461 |
| May 2001 | 472 |
| June 2001 | 535 |
| July 2001 | 622 |
| August 2001 | 606 |
| September 2001 | 508 |
| October 2001 | 461 |
| November 2001 | 390 |
| December 2001 | 432 |

What is claimed is:

1. A method performed in a business intelligence (BI) system, comprising:
examining a corresponding sequence of measurements for each key performance indicator (KPI) of a plurality of KPIs to identify a set of KPIs, wherein each corresponding sequence of measurements is over a respective sequence of time durations up to a first time duration; and
sending for display, said set of KPIs as being of interest for said first time duration,
wherein said set of KPIs are identified as being of interest without requiring user input for the identification of said set of KPIs in said plurality of KPIs for said first time duration.

2. The method of claim 1, wherein each KPI of said set of KPIs is determined based on a deviation of an actual value from a projected value for said first time duration.

3. The method of claim 2, for identifying said set of KPIs, said examining comprises:
computing a first range for deviation of said actual value from said projected value in relation to a first KPI for said first time duration based on the corresponding deviation between the actual value and the projected value in a respective time duration of said sequence of time durations for the first KPI; and
including the first KPI in said set of KPIs if said deviation is outside of said first range for the first KPI.

4. The method of claim 3, wherein said computing and identifying for said first KPI together further comprise:
calculating an upper limit as equaling a sum of the projected value and a positive threshold;
calculating a lower limit as equaling the projected value less a negative threshold, wherein said positive threshold and negative threshold define said first range; and
including said first KPI in said set of KPIs if the actual value of the first KPI is less than said lower limit or greater than said upper limit for the first KPI.

5. The method of claim 4, wherein the positive threshold equals the negative threshold, and is computed as a RMSE (root mean square error).

6. The method of claim 5, wherein a respective score is computed for each KPI of interest for said first time duration by dividing absolute difference between corresponding actual value and projected value for said first time duration by said RMSE, wherein said identifying further comprises:
sorting the plurality of KPIs based on the respective scores; and
picking the KPI with the highest score as containing most pertinent information.

7. The method of claim 6, wherein a respective set of KPIs of said plurality of KPIs are identified for each of a set of time durations, wherein said sets of KPIs are sent for display associated with respective set of time durations.

8. A non-transitory machine readable medium storing one or more sequences of instructions, wherein execution of said one or more instructions by one or more processors of a business intelligence (BI) system enables the BI system to perform the actions of:
examining a corresponding sequence of measurements for each key performance indicator (KPI) of a plurality of KPIs to identify a set of KPIs, wherein each corresponding sequence of measurements is over a respective sequence of time durations up to a first time duration; and
sending for display, said set of KPIs as being of interest for said first time duration,
wherein said set of KPIs are identified as being of interest without requiring user input for the identification of said set of KPIs in said plurality of KPIs for said first time duration.

9. The non-transitory machine readable medium of claim 8, wherein each KPI of said set of KPIs is determined based on a deviation of an actual value from a projected value for said first time duration.

10. The non-transitory machine readable medium of claim 9, for identifying said set of KPIs, said examining comprises:
computing a first range for deviation of said actual value from said projected value in relation to a first KPI for said first time duration based on the corresponding deviation between the actual value and the projected value in a respective time duration of said sequence of time durations for the first KPI; and
including the first KPI in said set of KPIs if said deviation is outside of said first range for the first KPI.

11. The non-transitory machine readable medium of claim 10, wherein said computing and identifying for said first KPI together further comprise:
calculating an upper limit as equaling a sum of the projected value and a positive threshold;
calculating a lower limit as equaling the projected value less a negative threshold, wherein said positive threshold and negative threshold define said first range; and
including said first KPI in said set of KPIs if the actual value of the first KPI is less than said lower limit or greater than said upper limit for the first KPI.

12. The non-transitory machine readable medium of claim 11, wherein the positive threshold equals the negative threshold, and is computed as a RMSE (root mean square error).

13. The non-transitory machine readable medium of claim 12, wherein a respective score is computed for each KPI of interest for said first time duration by dividing absolute difference between corresponding actual value and projected value for said first time duration by said RMSE, wherein said identifying further comprises:
sorting the plurality of KPIs based on the respective scores; and
picking the KPI with the highest score as containing most pertinent information.

14. The non-transitory machine readable medium of claim 13, wherein a respective set of KPIs of said plurality of KPIs are identified for each of a set of time durations, wherein said sets of KPIs are sent for display associated with respective set of time durations.

15. A business intelligence (BI) system comprising:
a random access memory (RAM) to store instructions;
one or more processors to retrieve said instructions and execute said instructions, wherein execution of said instructions causes said server system to perform the actions of:
examining a corresponding sequence of measurements for each key performance indicator (KPI) of a plurality of KPIs to identify a set of KPIs, wherein each corresponding sequence of measurements is over a respective sequence of time durations up to a first time duration; and
sending for display, said set of KPIs as being of interest for said first time duration,
wherein said set of KPIs are identified as being of interest without requiring user input for the identification of said set of KPIs in said plurality of KPIs for said first time duration.

16. The BI system of claim 15, wherein each KPI of said set of KPIs is determined based on a deviation of an actual value from a projected value for said first time duration.

17. The BI system of claim 16, for identifying said set of KPIs, said examining comprises:
computing a first range for deviation of said actual value from said projected value in relation to a first KPI for said first time duration based on the corresponding deviation between the actual value and the projected value in a respective time duration of said sequence of time durations for the first KPI; and
including the first KPI in said set of KPIs if said deviation is outside of said first range for the first KPI.

18. The BI system of claim 17, wherein said computing and identifying for said first KPI together further comprise:
calculating an upper limit as equaling a sum of the projected value and a positive threshold;
calculating a lower limit as equaling the projected value less a negative threshold, wherein said positive threshold and negative threshold define said first range; and
including said first KPI in said set of KPIs if the actual value of the first KPI is less than said lower limit or greater than said upper limit for the first KPI.

19. The BI system of claim 18, wherein the positive threshold equals the negative threshold, and is computed as a RMSE (root mean square error).

20. The BI system of claim 18, wherein a respective set of KPIs of said plurality of KPIs are identified for each of a set of time durations, wherein said sets of KPIs are sent for display associated with respective set of time durations.
